(19) United States
(12) Patent Application Publication
(10) Pub. No.: US 2011/0174875 A1
(43) Pub. Date: Jul. 21, 2011

(54) Charging station for electric vehicles

(76) Inventor: David T. Wurzer, Carroll, IA (US)

(21) Appl. No.: 12/657,229

(22) Filed: Jan. 15, 2010

(51) Int. Cl. G06F 17/00; H02J 7/00; G06K 7/00

(52) U.S. Cl. 235/380; 320/109

(57) ABSTRACT

A charging station is provided for charging an electric vehicle. The charging station preferably has dual voltage power outlets so as to be compatible with the vehicle being charged. The customer may select various charging times and may leave the vehicle unattended knowing that an unauthorized user may not remove the customer's charge plug from the outlet and replace the customer's plug with the plug of an unauthorized vehicle.

### BACKGROUND OF THE INVENTION

1. Field of the Invention

This invention relates to a charging station for charging an electric vehicle. More particularly, the charging station of this invention includes dual voltage outlets and means for the customer to select various charging times as well as a debit/credit card reader to enable the customer to pay for the power consumed during the charging operation. Even more particularly, the charging station of this invention includes means for preventing access to the electrical outlets prior to the customer paying for the charging power and for preventing the unauthorized removal of the vehicle charging plug from the outlet during the charging period.

2. Description of the Related Art

Apparently there have been previous attempts at providing means for permitting the recharging of an electric vehicle but it is believed that the prior art devices have not met with any success for one reason or another. It is believed that the prior art devices for charging electric vehicles are not convenient to use and do not provide the customer with the opportunity to select various charging times. It is also believed that the prior art devices do not include means for preventing access to the electrical outlets thereof prior to the time the customer has authorized payment for the selected charging time and which prevents the unauthorized removal of the vehicle charging plug from the outlet during the charging time. For example, if a customer inserts the electric vehicle charging plug into an outlet of the prior art devices and then leaves the vehicle unattended, a person could remove the customer's vehicle charging plug from the outlet and plug in his/her vehicle charging plug into the outlet without paying for the power consumed. Further, inasmuch as various electric vehicles utilize various charging voltages, it is desirable to provide a charging station including at least a pair of electrical outlets which have different voltages such as 120V and 240V. These are just some of the disadvantages of the prior art charging stations for electric vehicles.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A charging station is described for electric vehicles which comprises an upstanding support member having an interior compartment. A controller is positioned within the support member. A card reader is mounted on the support member adapted to have a debit/credit card inserted therein. The card reader is operatively connected to the controller. In the preferred embodiment, an optional communication screen and key pad is mounted on the support member which is capable of displaying information to a customer and for recording the responses thereto. The station also includes a charging time selector mounted on the support member whereby the customer may select a plurality of different times for charging. The charging time selector is operatively connected to the controller. In the preferred embodiment, a pair of electrical outlets are mounted on the support member and are at least partially enclosed by a pivotal door. The pair of outlets are electrically connected to sources of electrical power such as 120V and 240V with the outlets being operatively connected to the controller. The controller controls the ability of the outlets to supply electrical power to an electric vehicle for charging the same.

The pivotal doors on the charging station prevent access to the electrical outlets until the customer has paid for the power about to be consumed. After the charging plug from the vehicle has been inserted into the outlet, the door is closed and is locked in its closed position by a locking device so that the vehicle charging plug may not be removed from the outlet by an unauthorized person during the charging time.

The charging station of this invention preferably includes an optional transaction receipt dispenser. Additionally, the charging station of this invention preferably includes a transmission means for transmitting data from the station to a remote location for billing and accounting purposes.

It is therefore a principal object of the invention to provide an improved charging station for an electric vehicle.

A further object of the invention is to provide a charging station for electric vehicles which includes at least dual voltage electrical outlets associated therewith.

A further object of the invention is to provide a charging station for electric vehicles wherein the customer may select one of several charging times.

A further object of the invention is to provide a charging station for electric vehicles which prevents access to the electrical outlet or outlets thereof prior to the customer paying for the power to be consumed.

A further object of the invention is to provide a charging station for electric vehicles which includes means for preventing the unauthorized removal of a vehicle charging plug from the electrical outlet of the station during the charging time.

A further object of the invention is to provide a charging station for electric vehicles which includes a communication screen and key pad capable of displaying information to the customer.

Still another object of the invention is to provide a charging station for an electric vehicle which includes means for transmitting data to a remote location relative to the power consumed and the payment therefore.

Still another object of the invention is to provide a charging station for electric vehicles which includes a debit/credit card reader to enable the customer to pay for the power to be consumed.

A further object of the invention is to provide a charging station for electric vehicles which has the capability of providing customers with receipts for the charging services.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a front perspective view of a first embodiment of the charging station of this invention;

FIG. 2 is a front elevational view of the charging station of FIG. 1;

FIG. 3 is a side view of the charging station of FIG. 1;

FIG. 4 is a front perspective view of a second embodiment of the charging station;

FIG. 5 is a front elevational view of the charging station of FIG. 4;

FIG. 6 is a side view of the charging station of FIG. 4;

FIG. 7 is a front perspective view of a third embodiment of the charging station of this invention;

FIG. 8 is a front view of the charging station of FIG. 7;

FIG. 9 is a side view of the charging station of FIG. 7 with portions thereof cutaway to more fully illustrate the invention;

FIG. 10 is a front perspective view of a fourth embodiment of the invention illustrating the charging station of FIG. 7 attached to a support pole or post;

FIG. 11 is a front elevational view of the charging station of FIG. 10;

FIG. 12 is a side view of the charging station of FIG. 10 with portions thereof cutaway to more fully illustrate the invention;

FIG. 13 is partial exploded perspective view illustrating one of the electrical outlets of all of the embodiments of the invention;

FIG. 14 is a schematic of the circuitry of all of the embodiments of the invention;

FIG. 15A is a flow chart;

FIG. 15B is a continuation of the flow chart of FIG. 15A.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

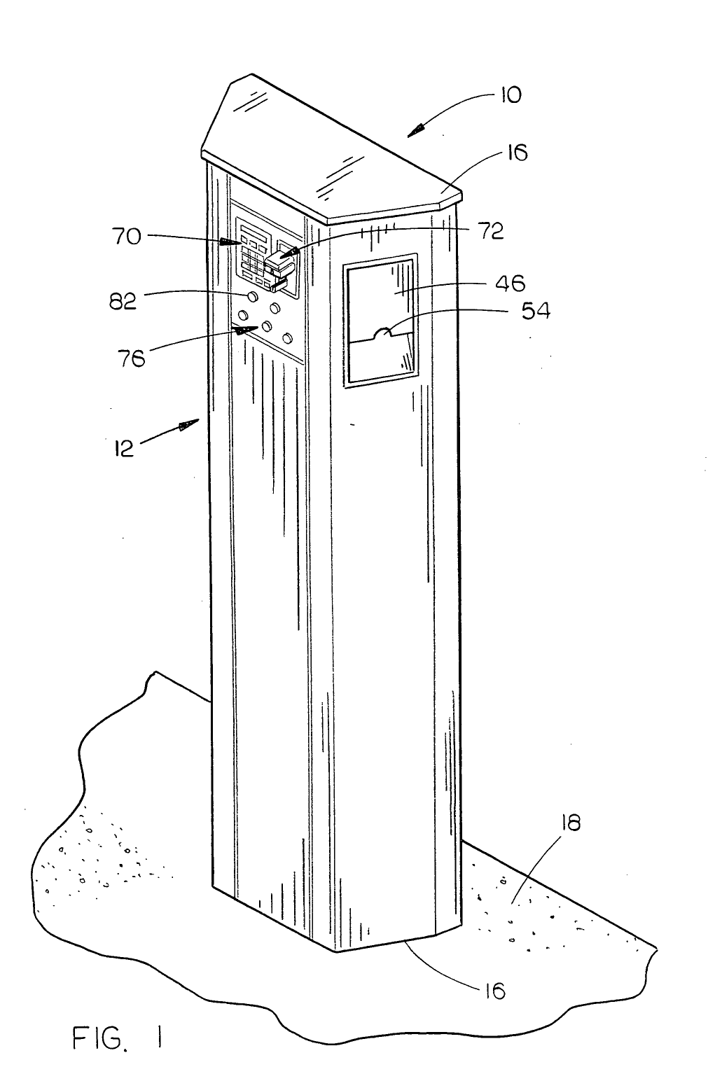

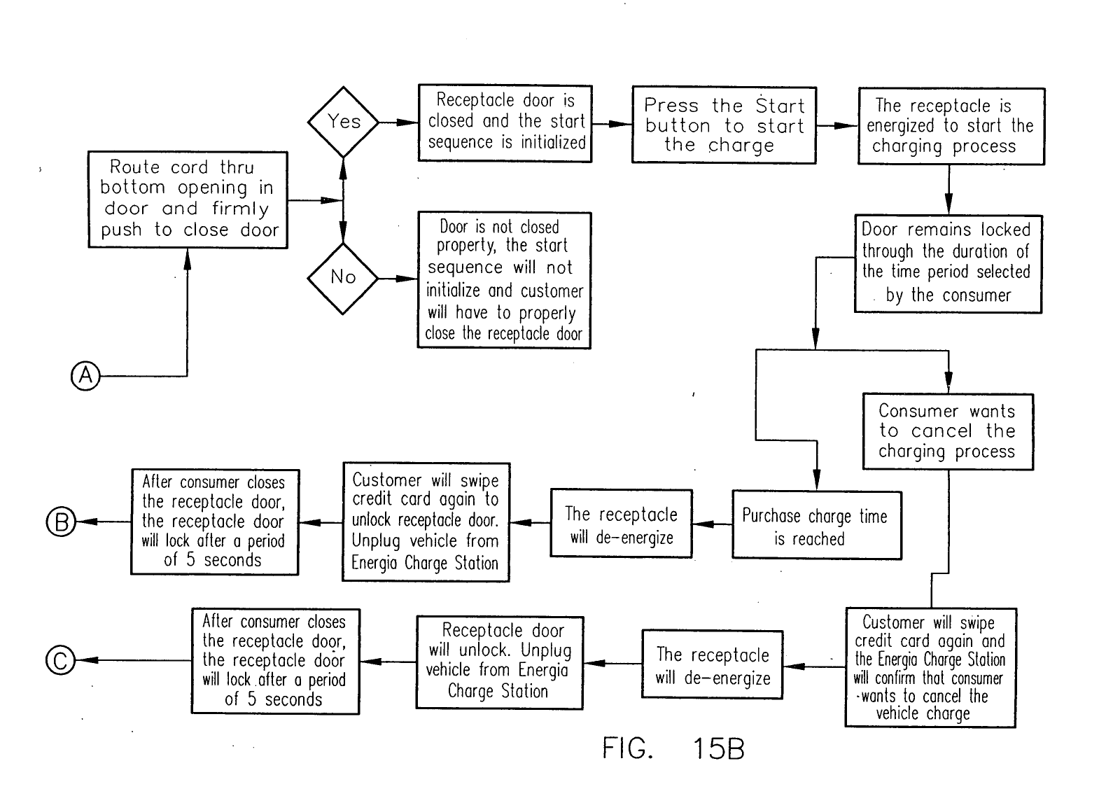

One embodiment of the charging station for electric vehicles is shown in FIGS. 1-3 and is designated by the reference numeral 10, the operation of which is set forth in the flow chart of FIGS. 15A and 15B. Station 10 includes an upstanding support member 12 which may be a post, tube, etc. and which may be of any desired height, width, etc. Support member 12 will be described as having an upper end 14 and a lower end 16. The lower end 16 of support member 12 is secured to a supporting surface or footing 18 by any convenient means. Support member 12 has an interior compartment 20, the lower end of which preferably has a pair of power conduits 22 and 24 extending upwardly thereunto from the footing 18. Conduits 22 and 24 are preferably connected to sources of 120V and 240V electrical power respectively. Although it is preferred that those two sources of electrical power with different voltages are supplied to the interior of the support member 12, a single power source could be utilized or more than two power sources could be utilized. Those power sources would be compatible to the electric vehicle being charged.

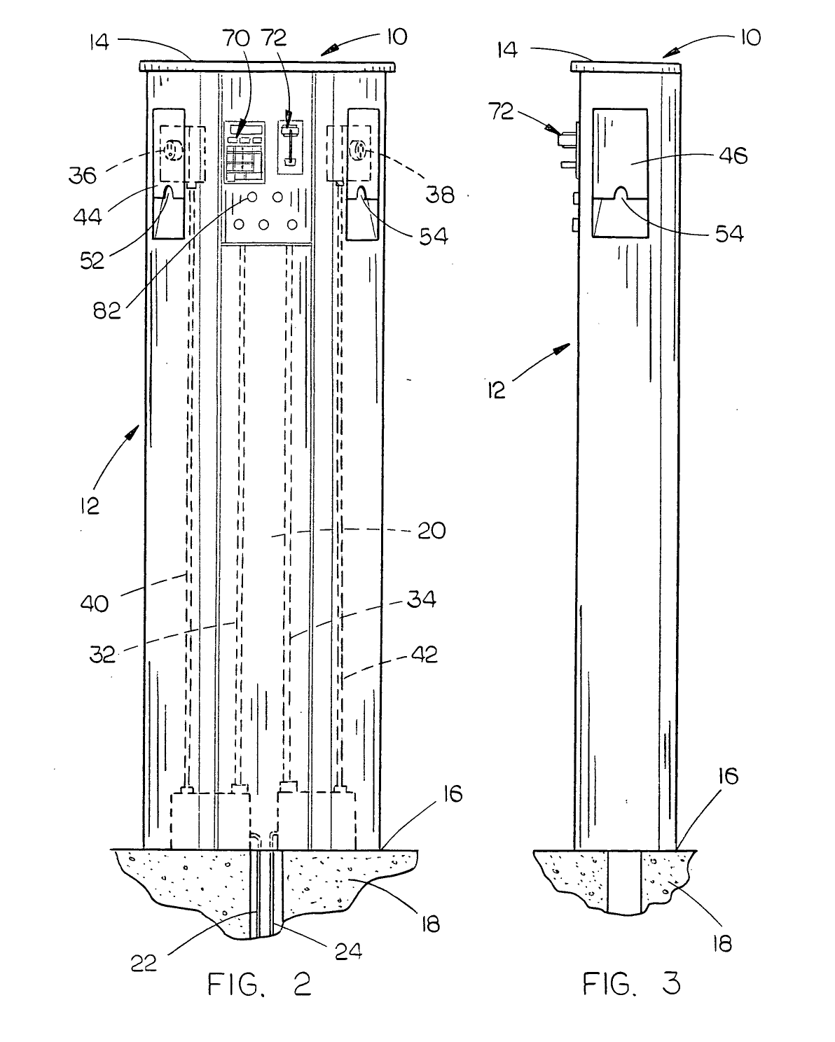

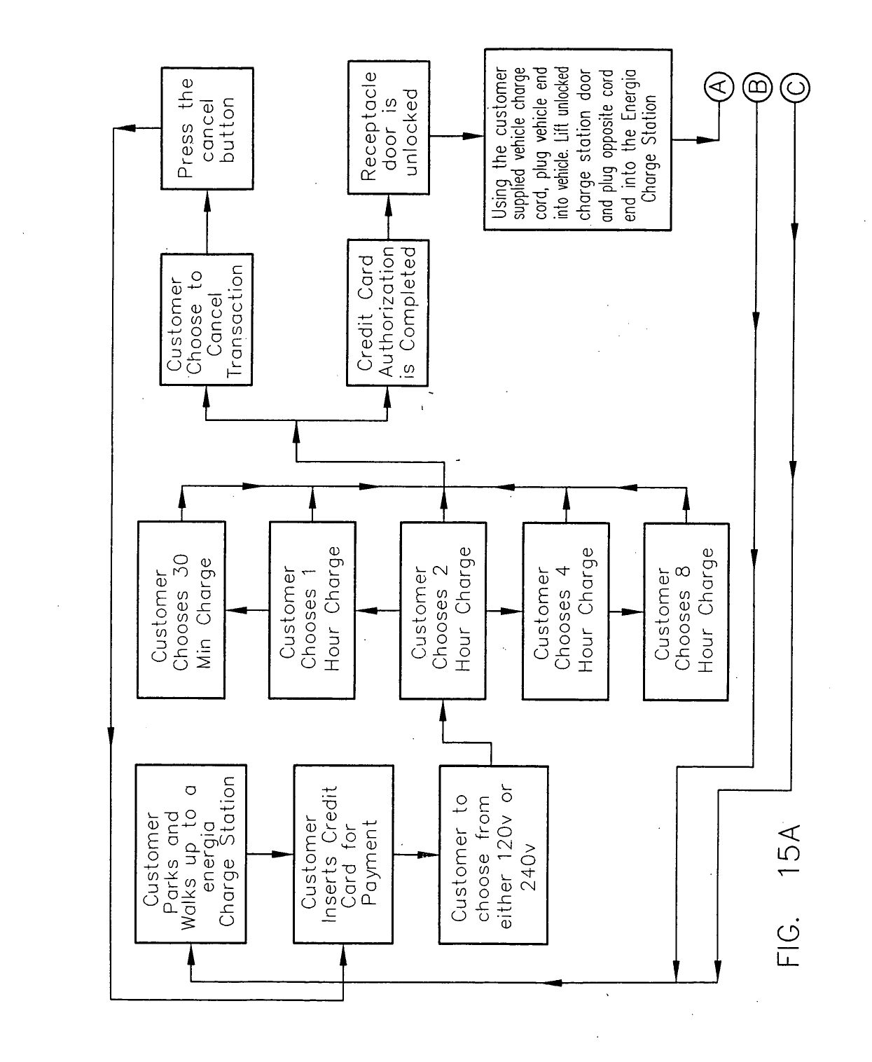

Power conduits 22 and 24 are connected to connector or contactor boxes 26 and 28 respectively as seen in FIGS. 2 and 14. Connector boxes 26 and 28 are electrically connected to a conventional controller 30 by leads 32 and 34 respectively. Connector boxes 26 and 28 are electrically connected to the 120V outlet 36 and the 240V outlet 38 respectively by leads 40 and 42 respectively.

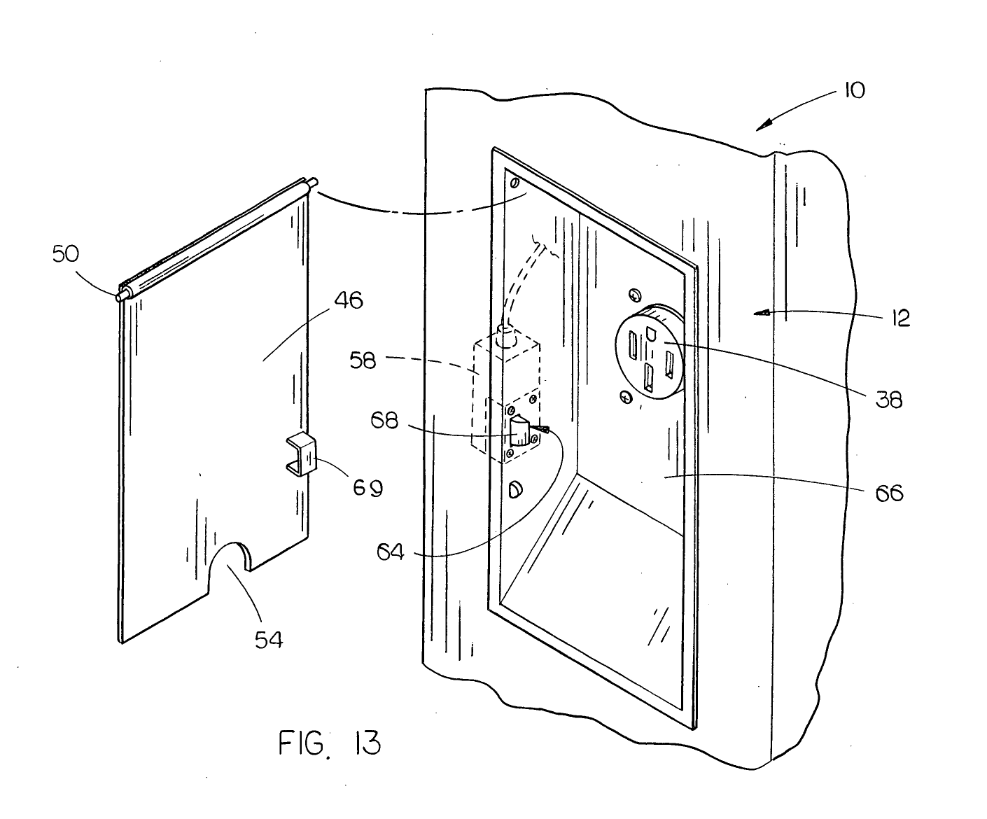

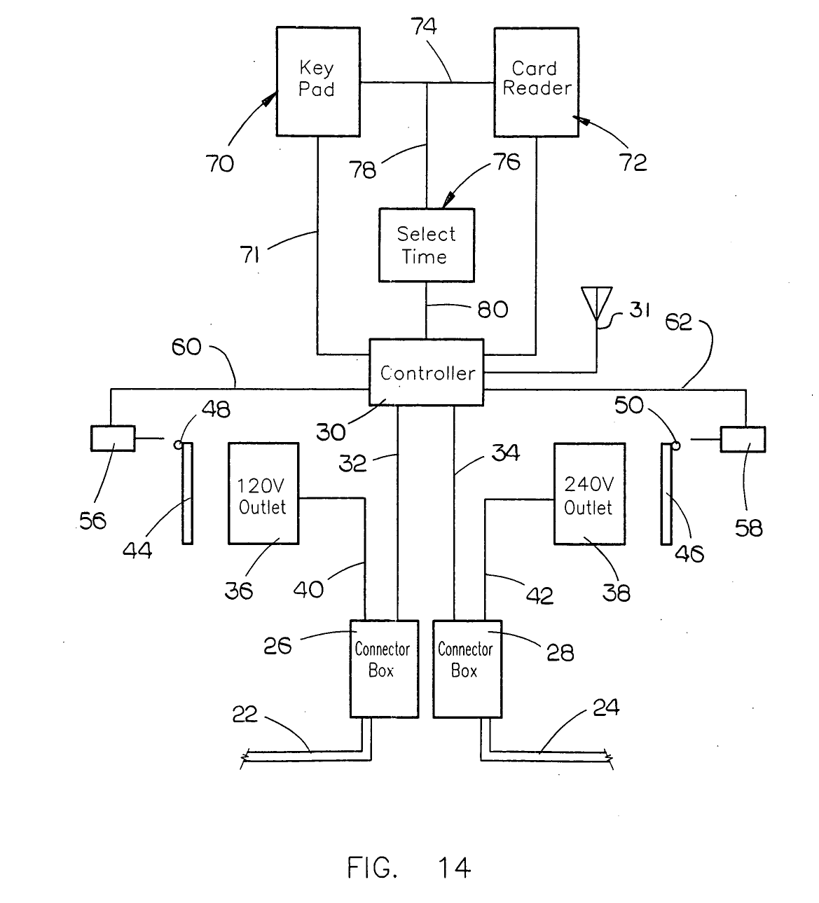

The outlets 36 and 38 are recessed in the support member 23 as seen in FIG. 13. The outlets 36 and 38 are at least partially closed by doors 44 and 46 respectively which are pivotally secured to support member 12 at their upper ends about horizontal axes 48 and 50 respectively. Doors 44 and 46 are pivotally movable between open and closed positions. When closed, the doors 44 and 46 at least partially cover the outlets 36 and 38 respectively. The lower ends of doors 44 and 46 have notches 52 and 54 formed therein respectively. Electric locking devices 56 and 58 are mounted on support member 12 in the interior thereof. The locking devices 56 and 58 are electrically connected to controller 30 by leads 60 and 62 respectively.

Inasmuch as the locking devices 56 and 58 are identical, only locking device 58 will be described in detail. Each of the locking devices 56 and 58 are manufactured by Southco, Inc., 210 North Brinton Lake Road, Concordville, Pa. 19331-0116 and which are designated EM-10 E-Keeper Latch System. Locking device 58 includes a spring loaded and electrically operated latch bolt 64 which protrudes into the outlet compartment 66 and which is normally in the latched position of FIG. 13 with the beveled side 68 of the latch bolt facing the outside of the support member 12. When locking device 64 is energized the latch bolt 68 is withdrawn into the locking device.

Door 46 has a bracket 69 extending inwardly therefrom as seen in FIG. 13. When door 46 is closed, latch bolt 68 is received within bracket 69 to prevent door 46 from moving from its closed position to its open position. Door 46 may be moved from its open position to its closed position when the latch bolt 68 is in its extended position since the bracket 69 will engage the beveled surface 68 of latch bolt 64 and move the latch bolt 64 inwardly into the device 58 against the resistance of the spring associated therewith. Once the bracket 69 has passed the latch bolt 64, the latch bolt 64 will spring outwardly to its extended position so that the back side of the latch bolt 64 engages the bracket 69 to prevent the door 46 from being moved from its closed position to its open position until the locking device 58 is actuated.

Controller 30 is electrically connected to a key pad communication screen 70, which is optional but preferred, by lead 71 to provide information to the customer. A conventional debit/credit card reader 72 is connected to key pad communication screen 70 by lead 74. A select time mechanism 76 is connected to lead 74 by lead 78 and controller 30 by lead 80. Preferably, the select time mechanism 76 will permit the customer to choose charging times such as a 30-minute charge time, a one-hour charge time, a two-hour charge time, a four-hour charge time, and an eight-hour charge time by depressing one of the buttons 82, 84, 86, 88 or 90.

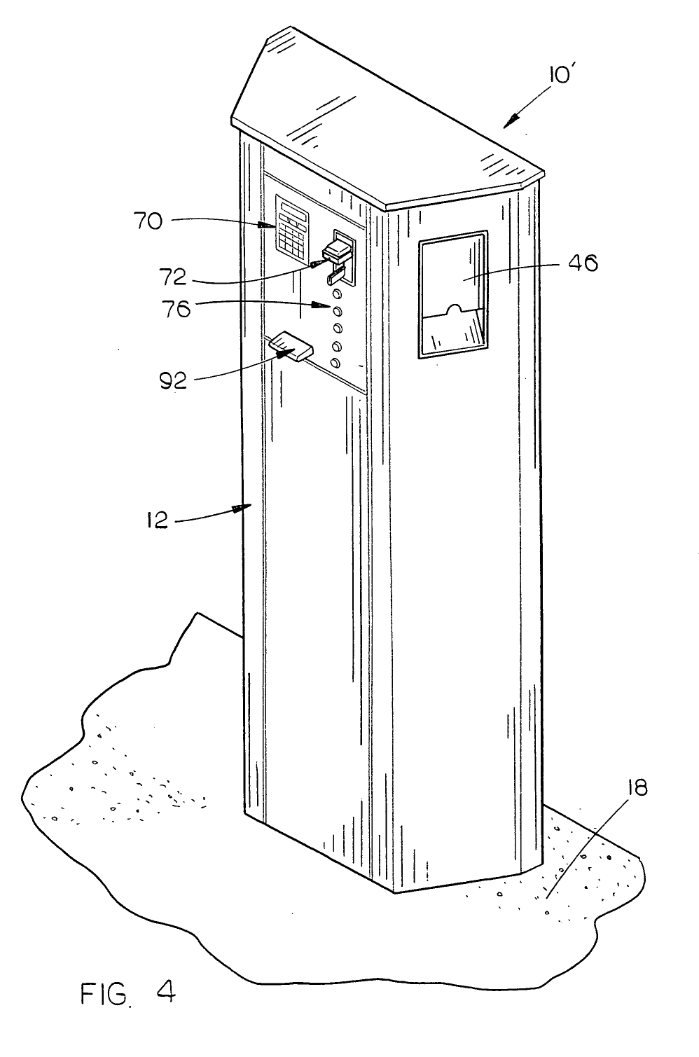

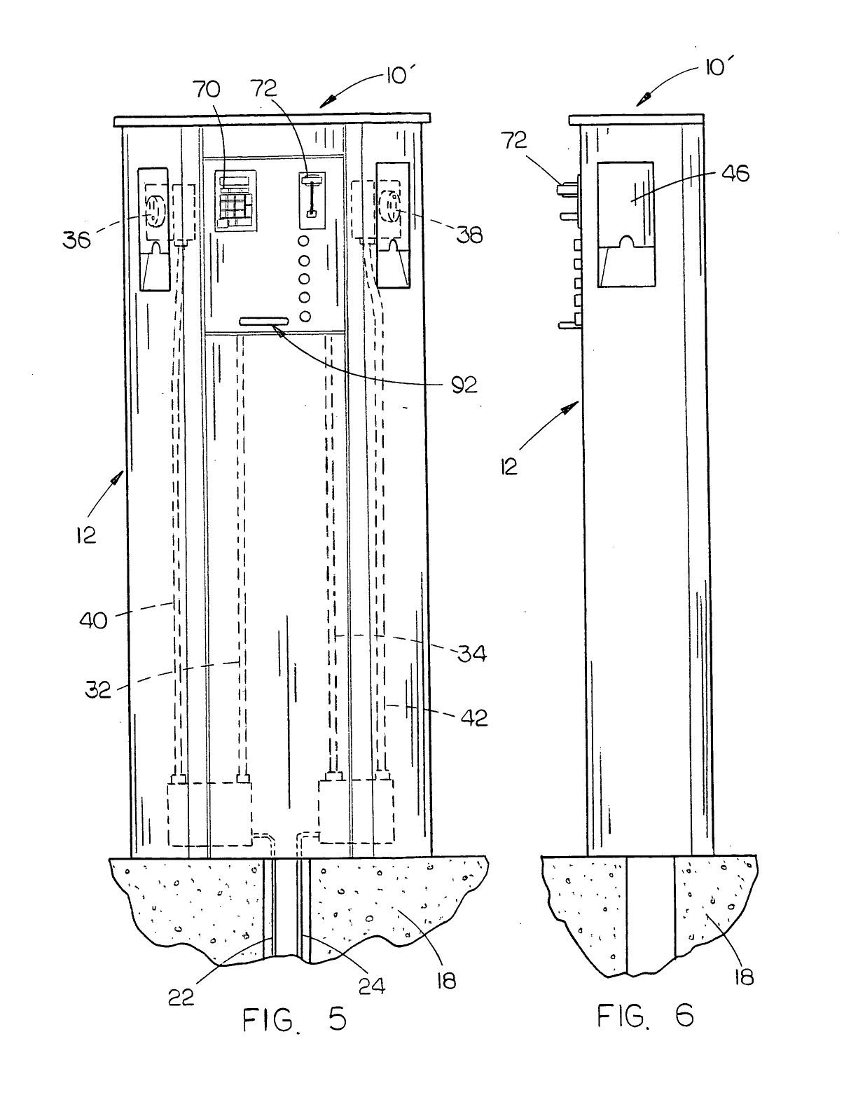

A modified form of the charging station is shown in FIGS. 4-6 which is identical to station 10 except that a transaction receipt dispenser 92 is provided on the support member and the buttons of the select time mechanism 76 are arranged somewhat differently than on the station 10. The charging station embodiment of FIGS. 4-6 is referred to by the reference numeral 10′.

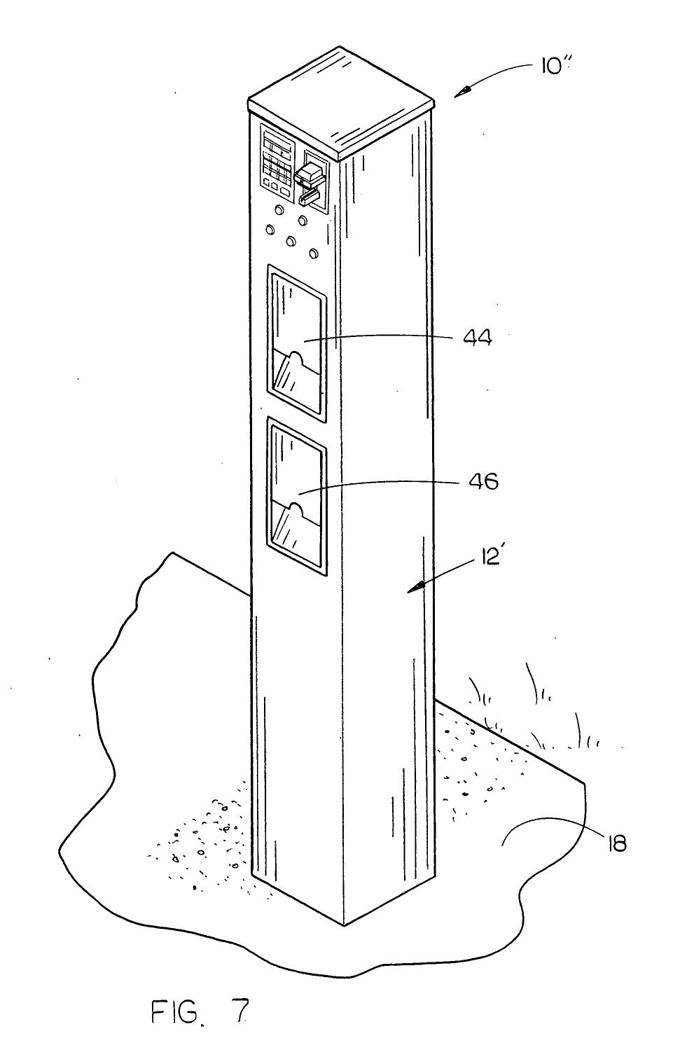

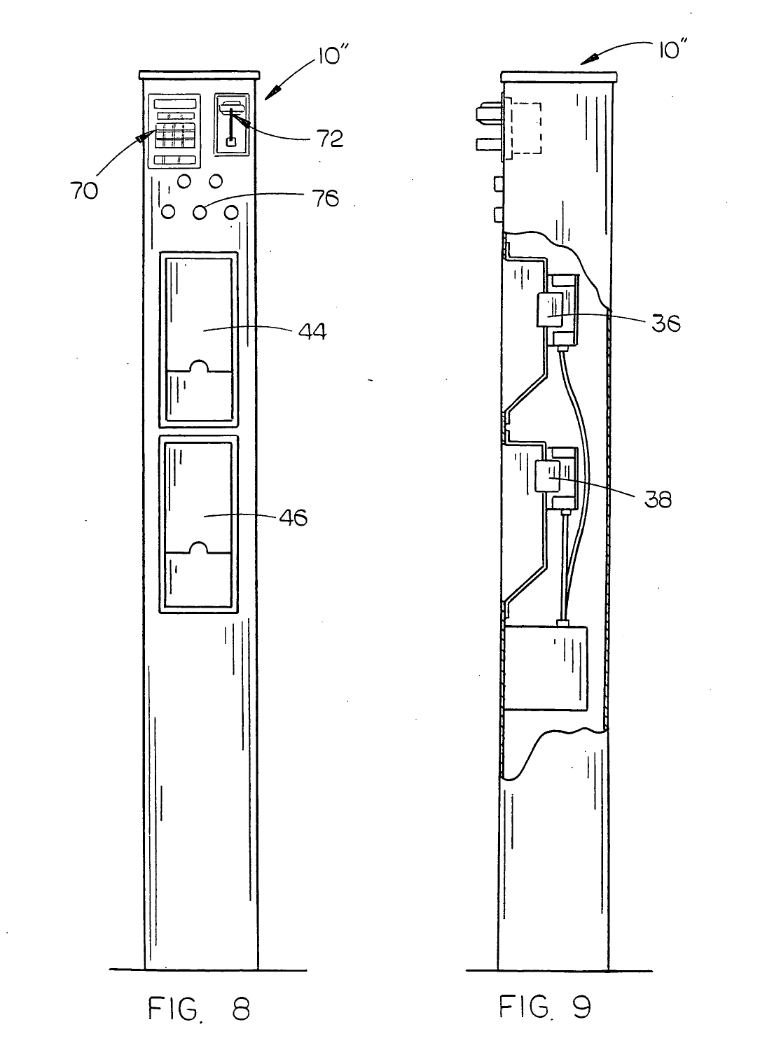

A further embodiment or modification of the charging station is illustrated in FIGS. 7-9 and is referred to by the reference numeral 10″. The only difference between the charging station 10″ and the charging stations of FIGS. 1-6 is that the support member 12 is square and the electrical outlets are provided at the front of the support member.

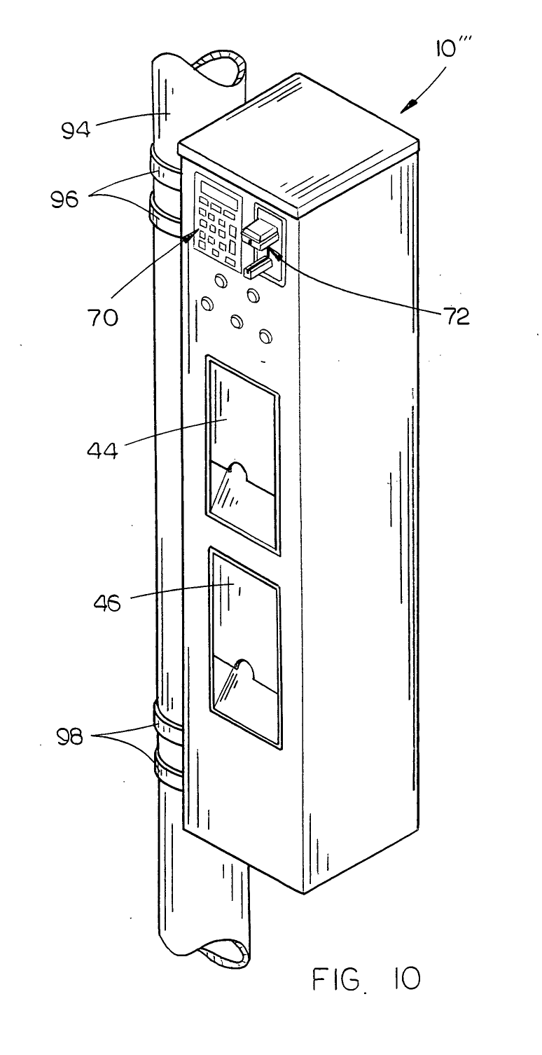

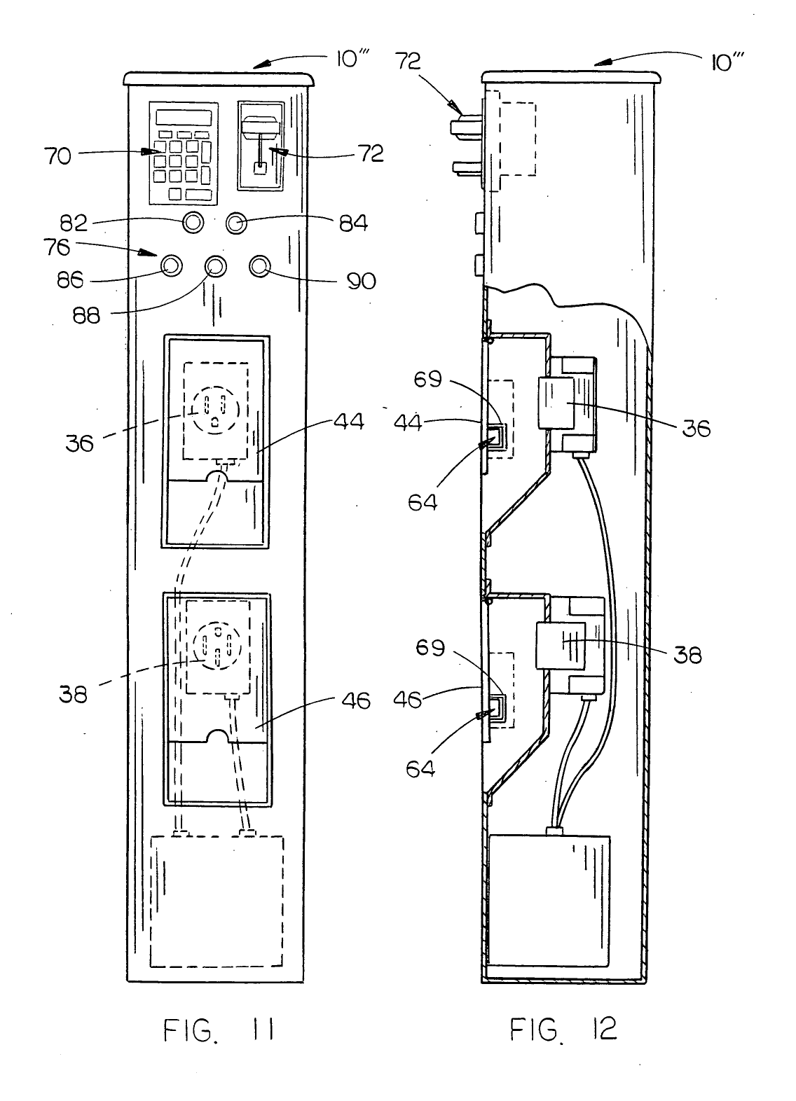

A further modification or embodiment of the charging station is illustrated in FIGS. 10-12 and is referred to generally by the reference numeral 10′″. Charging station 10′″ is different than the embodiment of FIGS. 7-9 only in that it is secured to a support pole or post 94 by connectors 96 and 98.

Using FIGS. 15A and 15B as a guide, the system of this invention is used as follows. The customer parks his/her vehicle adjacent the charging station 10 and walks up to the charging station. The customer then inserts his/her credit/debit card into the card reader 72 for payment. The customer is then able to choose from either 120V and 240V and may then choose charging times such as 30 minutes, one hour, two hour, four hour, or eight hour charging times for his/her vehicle. Should the customer choose to cancel the transaction, the customer will press the cancel button on the key pad 70.

After the credit/debit card has been authorized and the customer has chosen the desired charging time, the controller 30 will then either actuate the locking device 56 or the locking device 58 dependent upon which voltage the customer has chosen. Assuming that the customer has chosen to use the 240V outlet 38, the locking device 58, which previously has locked the door 46 in its closed position to deny access to the outlet 38, the latch bolt 64 of the locking device 58 will be retracted so that the door 46 may be manually moved to its open position. Using the customer supplied vehicle charge cord, the customer will plug the vehicle plug end into the vehicle. The customer will then lift the unlocked charge station door 46 and plug the opposite end of the vehicle charge cord into the outlet 38. The cord of the vehicle charge cord will be routed from the outlet 38 outwardly through the lower end of the compartment 66. The customer will then firmly push the door 46 from its open position to its closed position with the notch 54 providing a partial path for the vehicle charge cord. The door 46 may be closed since the bracket 69 will engage the beveled surface 68 of the latch bolt 64 to depress the same until the bracket 69 is positioned to receive the spring loaded latch bolt 64 to lock the door 46 in its locked position thereby denying unauthorized access to the outlet 38 during the charge time to prevent an unauthorized user from opening the door 46, removing the customer's vehicle charge cord from the outlet 38 and plugging his/her vehicle charge cord into the outlet 38 to receive unauthorized power.

After the door 46 has been firmly closed, the start sequence is initialized as indicated in FIG. 15B. If the door 46 is not closed properly, the start sequence will not initialize and the customer will have to properly close the receptacle door 46. The customer will then press the start button on the key pad 70 to start the charging cycle. The receptacle 38 is then energized to start the charging process. The door 46 remains locked throughout the duration of the charging time period selected by the consumer. If the customer or consumer wishes to cancel the charging process, the customer will swipe his/her credit/debit card again and the charge station 10 will confirm that the consumer wishes to cancel the vehicle charge. The receptacle 38 will then be deenergized and a receptacle door 46 will unlock. The customer may then unplug the vehicle from the charge station. After the customer closes the receptacle door 46 upon removing the charge plug therefrom, the receptacle door will lock after a period of five seconds.

If the customer has not cancelled the charging process as indicated in FIG. 15B, the vehicle will be charged until the purchased charge time has been reached. The receptacle 38 will then be deenergized and the customer will swipe the credit/debit card again to unlock the receptacle door 46. The customer will then unplug the vehicle from the charge station. After the customer closes the door 46, the receptacle door 46 will lock after a period of five seconds. The controller 30 may either send credit/debit card data or power consumption data to a remote location either by hard wire or by RF, generally designated by the reference numeral 31.

It can therefore be seen that a novel charging station has been provided which is convenient to use and which provides at least dual voltages which are compatible to the electrical system of the electric vehicle being charged. It can also be seen that the charge station of this invention is user friendly and is designed so the customer is assured that the customer may leave the charging car unattended since no one can open the door 46 to receive unauthorized power at the customer's expense.

It can therefore be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. A charging station for electric vehicles, comprising:
an upstanding support member having an interior compartment;
a controller positioned within said support member;
a card reader mounted on said support member adapted to have a credit or debit card inserted therein;
said card reader being operatively connected to said controller;
a charging time selector mounted on said support member whereby the customer may select a time for charging;
said charging time selector being operatively connected to said controller;
at least one electrical outlet mounted on said support member;
said outlet being electrically connected to a source of electrical power;
said outlet being operatively connected to said controller;
said controller controlling the ability of said outlet to supply electrical power to an electric vehicle for electrically charging the same.

2. The charging station of claim 1 wherein first and second electrical outlets are mounted on said support member and are electrically connected to sources of electrical power having different voltages.

3. The charging station of claim 1 wherein a communication screen is mounted on said support member which is capable of displaying information to a customer.

4. The charging station of claim 2 wherein a communication screen is mounted on said support member which is capable of displaying information to a customer.

5. The charging station of claim 2 wherein said first and second outlets are 120V and 240V respectively.

6. The charging station of claim 1 further including a transaction receipt dispenser.

7. The charging station of claim 2 further including pivotal doors which extend at least over a portion of said outlets.

8. The charging station of claim 7 wherein said pivotal doors are controlled by said controller.

9. The charging station of claim 1 further including a RF transmitter which transmits transaction data to a remote location.

10. The charging station of claim 3 wherein said communication screen includes a key pad.

11. The charging station of claim 4 wherein said communication screen includes a key pad.

12. The charging station of claim 8 wherein each of said pivotal doors are movable between open and closed positions and further including locking devices operatively controlled by said controller which normally locks said doors in their closed positions.

13. The charging station of claim 12 wherein said controller unlocks at least one of said doors when the customer has been approved for use to enable the customer to insert a vehicle power recharge plug into the outlet.

14. The charging station of claim 13 wherein the locking device is locked upon the insertion of the recharge plug into the outlet and associated door is moved to its closed position.

15. The charging station of claim 14 wherein the locking device is unlocked after the charging time has elapsed and the customer has reinserted his/her credit/debit card into said card reader.
